(19) United States
(12) Patent Application Publication
(10) Pub. No.: US 2017/0146031 A1
(43) Pub. Date: May 25, 2017

(54) FAN FOR A ROTARY ELECTRICAL MACHINE

(71) Applicant: VALEO EQUIPEMENTS ELECTRIQUES MOTEUR, Creteil Cedex (FR)

(72) Inventors: Michel FAKES, Seclin (FR); André SAUVIGNET, Massy (FR); Erwan LE GOFF, Verrieres Le Buisson (FR); Laurent DAHINE, Ivry Sur Seine (FR)

(21) Appl. No.: 15/310,246

(22) PCT Filed: Apr. 17, 2015
(86) PCT No.: PCT/FR2015/051041

§ 371 Date: Nov. 10, 2016

(30) Foreign Application Priority Data
May 14, 2014 (FR) 1454286

(51) Int. Cl. F04D 29/66; H02K 9/06; F04D 29/28; H02K 7/14

(52) U.S. Cl. CPC F04D 29/666; H02K 7/14; H02K 9/06; F04D 29/281

(57) ABSTRACT

A fan (100) of a rotary electric machine comprising at least three blades (101) in which at least one property of the blades is, following the circumference of the fan in a given direction, gradual for at least three consecutive blades, the property being chosen from the group including: a spacing angle (102) between a straight line passing through a characteristic point (103) of a blade and an axis of rotation of the fan (104), and a straight line passing through a corresponding characterising point (105) of an adjacent blade and the axis of rotation of the fan; a height of the blade; a length of the blade; and an angle of inclination between a straight line passing through two characteristic points of a blade and a straight line passing through two corresponding characteristic points of an adjacent blade.

### FIELD OF THE INVENTION

The present invention relates to a fan for a rotary electrical machine, as well as to a vehicle comprising a device of this type.

The present invention applies in particular in the field of motor vehicles, and more particularly to rotary electrical machines such as motors, alternators and alternator-starters.

### PRIOR ART

The purpose of fans for rotary electrical machines is to cool the machine. However, since these machines can have speeds of rotation of up to approximately 18,000 revolutions per minute and more, substantial noise can be produced by the mechanism.

In order to avoid the emergence of harmonics, and thus of noise caused by the fan, it is common to position the blades asymmetrically. However, this technique does not guarantee the non-emergence of harmonics. In fact, the environment of the fan can play a part in whether harmonics emerge or not, for example the closeness of another part of the electrical machine.

It is therefore necessary to improve the fans of electrical machines constantly in order to reduce the noise of the mechanism.

### SUMMARY OF THE INVENTION

The objective of the present invention is to eliminate some or all of these disadvantages.

For this purpose, according to a first aspect, the invention relates to a fan for a rotary electrical machine comprising at least three blades, wherein at least one characteristic of the blades is, according to the circumference of the fan in a given direction, progressive for at least three consecutive blades, the characteristic being able to be selected from the group comprising:

a spacing angle between a straight line passing via a characteristic point of the blade and an axis of rotation of the fan, and a straight line passing via a corresponding characteristic point of an adjacent blade and the axis of rotation of the fan;

a height of the blade;

a length of the blade; and

an angle of inclination between a straight line passing via two characteristic points of blade, and a straight line passing via two corresponding characteristic points of an adjacent blade.

In other words, according to a first alternative, a spacing angle between a straight line passing via a characteristic point of the blade and the axis of rotation of the fan, and a straight line passing via a corresponding characteristic point of an adjacent blade and the axis of rotation of the fan is, according to the circumference of the fan in a given direction, progressive for at least three consecutive blades.

According to a second alternative, the height of the blade is, according to the circumference of the fan in a given direction, progressive for at least three consecutive blades.

According to a third alternative, a length of the blade is, according to the circumference of the fan in a given direction, progressive for at least three consecutive blades.

According to a fourth alternative, an angle of inclination between a straight line passing via two characteristic points of the blade, and a straight line passing via two corresponding characteristic points of an adjacent blade is, according to the circumference of the fan in a given direction, progressive for at least three consecutive blades.

The progressiveness of at least one characteristic for at least three blades makes it possible to limit the emergence of harmonics and reduce the noise of the electrical machine. The effect is all the more noticeable during idling. The comfort of the user is thus increased.

In some embodiments, at least one characteristic of the blades is progressive for all of the blades of the fan.

The advantage of these embodiments is to have progressiveness concerning all the blades of the fan. Thus the emergence of harmonics is reduced.

In some embodiments, the number of blades of the fan which is the subject of the present invention is a prime number.

These embodiments have the advantage of improving the reduction of noises caused by the fan.

In some embodiments, the sum of the spacing angles between the blades is equal to 360°.

The advantage of these embodiments is to have distribution of the blades which can be implemented, and more particularly in the case when the fan comprises two parts comprising blades assembled by welding.

In some embodiments, the smallest distance between two consecutive blades is more than 3 mm.

A minimum distance of 3 mm permits adequate circulation of the air in the machine.

In some embodiments, the minimum length of arc between two blades is more than 3 mm.

These embodiments have the advantage of permitting a minimum distance necessary for displacement of masses of air by the blades of the fan in order to cool the machine.

In some embodiments, the progressiveness of the spacing angles between the blades is defined by a positive function.

A function which governs the progressiveness of the spacing angles has the advantage of defining a method for reproducible calculation of the progressiveness of the angles.

In some embodiments, the function of progressiveness of the spacing angles between the blades is linear.

The advantage of having a linear function is to have an increase in the spacing angles which is augmented regularly, or a decrease in the spacing angles which is reduced regularly.

In some embodiments, the ratio between the largest spacing angle between two blades and the smallest spacing angle between two blades is more than 1.2.

A ratio of this type has the advantage of creating substantial progressiveness of the spacing angles between the blades, thus improving the reduction of noises.

In some embodiments, the progressiveness of the length of the blade is defined by a positive function.

A function which governs the progressiveness of the lengths has the advantage of defining a method for reproducible calculation of the progressiveness of the lengths.

In some embodiments, the function of progressiveness of the length of the blade is linear.

The advantage of having a linear function is to have an increase in the lengths which is augmented regularly, or a decrease in the lengths which is reduced regularly.

In some embodiments, the ratio between the length of the largest blade and the length of the smallest blade is more than 1.2.

These embodiments have the advantage of creating substantial progressiveness between the lengths of the different blades, and improving the reduction of noises.

In some embodiments, the progressiveness of the height of the blade is defined by a positive function.

A function which governs the progressiveness of the heights of the blade has the advantage of defining a method for reproducible calculation of the progressiveness of the heights.

In some embodiments, the function of progressiveness of the height of the blade is linear.

The advantage of having a linear function is to have an increase in the heights which is augmented regularly, or a decrease in the heights which is reduced regularly.

In some embodiments, the ratio between the height of the largest blade and the height of the smallest blade is more than 1.2.

These embodiments have the advantage of creating substantial progressiveness between the lengths of the different blades, and of improving the reduction of noises.

In some embodiments, the progressiveness of the angles of inclination between the blades is defined by a positive function.

A function which governs the progressiveness of the lengths has the advantage of defining a method for reproducible calculation of the progressiveness of the lengths.

In some embodiments, the function of progressiveness of the angles of inclination between the blades is linear.

The advantage of having a linear function is to have an increase in the heights which is augmented regularly, or a decrease in the heights which is reduced regularly.

In some embodiments, the ratio between the largest angle of inclination and the smallest angle of inclination is more than 1.2.

These embodiments have the advantage of creating substantial progressiveness between the lengths of the different blades and improving the reduction of noises.

In some embodiments, at least two characteristics of the blades are progressive.

The advantage of these embodiments is, for some of the blades, to have progressiveness in height, whereas progressiveness of the angles of inclination is applied to others of the blades. Better balancing can thus be obtained.

In some embodiments, the progressiveness of at least one characteristic of the blade depends on the progressiveness of at least one other characteristic of the blade.

These embodiments have the advantage of permitting better distribution of the material if the lengths increase, whereas the heights decrease for example. These embodiments permit better balancing, as well as constancy for example of the surface of the blades which is configured to displace the masses of air homogenously.

In some embodiments, the fan which is the subject of the present invention comprises progressive distribution of material configured to balance the fan according to the progressiveness of at least one characteristic of at least three blades.

Progressive distribution of material makes it possible to balance the fan, whilst being inversely proportional to the distribution of material of the blades for example.

In some embodiments, the progressive distribution of material is carried out by addition of material.

These embodiments have the advantage of balancing the fan irrespective of the number of blades and their forms. In addition, the contact surface between a face of the fan and a face of the magnet wheel is large.

In some embodiments, the addition of material is carried out by depositing material, the quantity of which increases according to the circumference of the fan in a given direction.

Addition of material of this type has the advantage of permitting balanced distribution of the material on the fan.

In some embodiments, the depositing is situated on the periphery of an axial hole in the fan.

These embodiments have the advantage of not increasing the volume of the fan.

In some embodiments, the progressive distribution of material is carried out by removal of material.

The advantage provided by these embodiments is the balancing of the fan, irrespective of the number of blades and their forms. In addition, elimination of material in relation to the fan without balancing by distribution of material is less onerous for example if the elimination of material has been designed to take place during the moulding of the part.

In some embodiments, the production material of at least one part of the fan comprises mostly aluminum.

Since aluminum is a light material, the weight of the rotary electrical machine will be reduced.

In some embodiments, at least one part of the fan is obtained from sheet metal.

Since the cost of machining and purchasing sheet metal is low, the cost of the fan and the rotary electrical machine will be reduced.

In some embodiments, at least one part of the fan is obtained by bending.

The advantage of these embodiments is the speed of the bending and thus the decrease in the production cost of mass-produced fans.

In some embodiments, at least one part of the fan is made of plastic material.

These embodiments have the advantage of having a part made of a light, non-oxidising material.

In some embodiments, at least one part of the fan is obtained by moulding.

The advantage provided by these embodiments is to have a production method which can be adapted to the different embodiments previously described.

In some embodiments, the fan which is the subject of the present invention is obtained by assembling two parts comprising blades.

Assembly of two parts comprising blades has the advantage of obtaining a decrease in the noise and ease of manipulation of the parts during the different production and machining operations.

According to a second aspect, the present invention relates to a vehicle which comprises at least one fan which is the subject of the present invention.

Since the advantages, objectives and particular characteristics of the vehicle which is the subject of the invention are similar to those of the fan which is the subject of the present invention, they will not be described again here.

### BRIEF DESCRIPTION OF THE FIGURES

Other advantages, objectives and characteristics of the invention will become apparent from the following non-limiting description of at least one particular embodiment of the fan and of the vehicle comprising a fan of this type, in relation to the appended drawings in which:

FIG. 1 represents schematically and in plan view a first embodiment of a device which is the subject of the present invention;

FIG. 2 represents schematically and in plan view a second embodiment of a device which is the subject of the present invention;

FIG. 3 represents schematically and in perspective an embodiment of a symmetrical fan;

FIG. 4 represents schematically a graph which is representative of a harmonic of order twenty nine generated by an embodiment of a symmetrical fan and an embodiment of a fan which is the subject of the present invention;

FIG. 5 represents schematically and in plan view a third embodiment of a device which is the subject of the present invention;

FIG. 6 represents schematically and in perspective a fourth embodiment of a device which is the subject of the present invention;

FIG. 7 represents schematically and in perspective a fifth embodiment of a device which is the subject of the present invention;

FIG. 8 represents schematically and in perspective a sixth embodiment of a device which is the subject of the present invention;

FIG. 9 represents schematically and in perspective a seventh embodiment of a device which is the subject of the present invention; and

FIG. 10 represents schematically and in plan view a vehicle which is the subject of the present invention.

### DESCRIPTION OF EMBODIMENTS OF THE INVENTION

It should hereby be noted that the figures are not to scale.

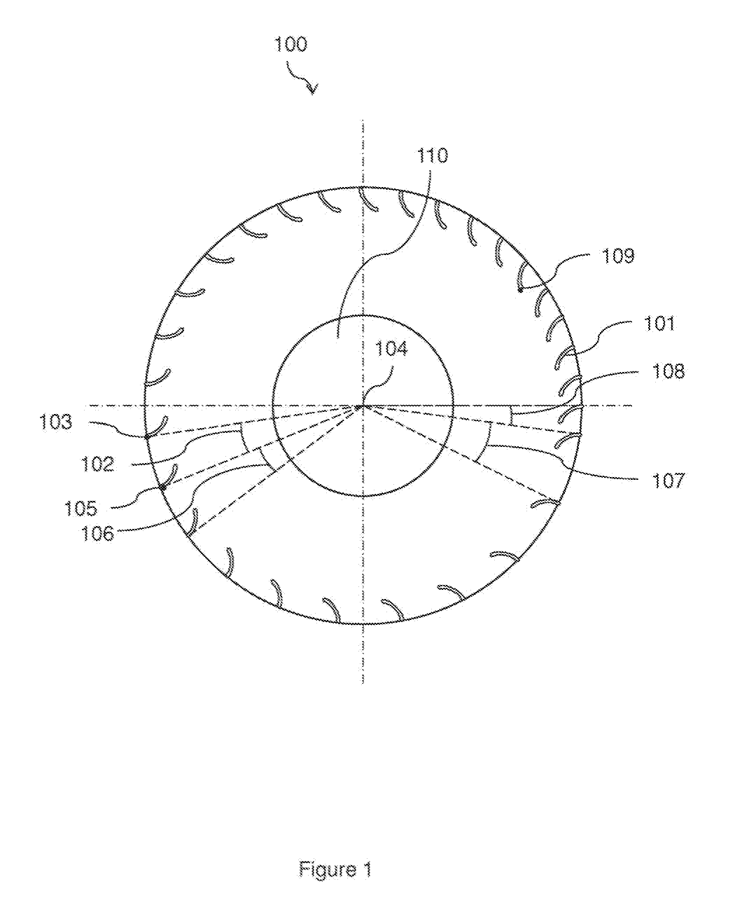

FIG. 1 represents a front view of a particular embodiment 100 of a fan which is the subject of the present invention.

The device comprises blades 101. Preferably, the number of blades 101 is a prime number. The device can comprise blades arranged perpendicularly to a face. The face can comprise an axial hole 110 which receives a shaft of a rotor of a rotary electrical machine. The face is preferably described by an outer diameter. In some embodiments, the blades 101 are concave.

In some embodiments, the blades are convex or straight.

Spacing angles between the blades can follow a progressive distribution. A spacing angle 102 can be defined between:
a straight line passing via:
   a characteristic point 103, known as the end of blade point, which can be the point of the blade, on the face of the fan comprising the blades, and on the outer face of the blade, which point is the furthest from the axis of rotation of the fan; and
   the axis of rotation 104 of the fan;
a straight line passing via:
   a characteristic point 105 on an adjacent blade also characterised as being an end of blade point; and
   the axis of rotation 104 of the fan.

In some embodiments, the characteristic point can be a point known as the start of blade point. The start of blade point 109 is for example the point of the blade, on a face of the fan comprising the blades, and on the outer face of the blade, which point is closest to the axis of rotation of the fan

The progressiveness between a spacing angle 102 and an adjacent spacing angle 106 can be characterised by a positive function. Preferably, this function is linear and has a strictly positive slope. In some embodiments, the slope is strictly greater than 1.

The progressiveness of the angular distribution of the blades is preferably applied to all the blades. In some embodiments, the progressiveness of the angular distribution is applied to at least three blades.

The angular distribution of the blades is such that the sum of the spacing angles between the corresponding characteristic points is equal to 360°.

The ratio between the smallest spacing angle 108 and the largest spacing angle 107 is preferably more than 1.2.

Preferably, the minimum length of arc between two blades is more than 3 mm. For example, the smallest distance between two consecutive blades is more than 3 mm. The length of arc can be calculated between two end of blade points and two adjacent blades between which the spacing angle is the smallest spacing angle 108.

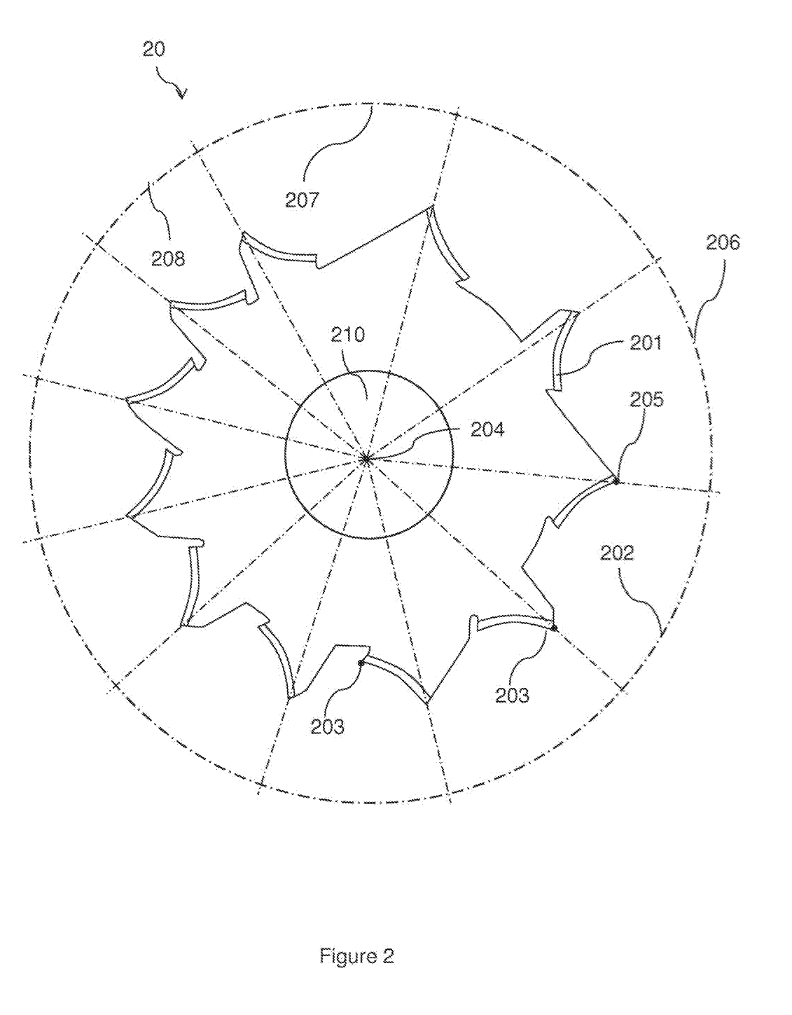

FIG. 2 shows a front view of an embodiment 20 of a fan which is the subject of the present invention.

The device comprises blades 201. Preferably, the number of blades 201 is a prime number. The device can comprise blades which are arranged perpendicularly to a face. The face can comprise an axial hole 210 which receives a shaft of a rotor of a rotary electrical machine.

The face is preferably described by an outer diameter. The spaces between the blades can be empty of material, and create teeth on which the blades are located.

In some embodiments, the blades 201 are concave. In some embodiments, the blades are convex or straight.

Spacing angles between the blades can follow a progressive distribution. A spacing angle 202 can be defined between:
a straight line passing via:
   a characteristic point 203, known as the end of blade point, which can be the point of the blade, on the face of the fan comprising the blades, and on the outer face of the blade, which point is the furthest from the axis of rotation of the fan; and
   the axis of rotation 204 of the fan;
a straight line passing via:
   a characteristic point 205 on an adjacent blade also characterised as being an end of blade point; and
   the axis of rotation 204 of the fan.

In some embodiments, the characteristic point can be a point known as the start of blade point. The start of blade point 209 is for example the point of the blade, on a face of the fan comprising the blades, and on the outer face of the blade, which point is closest to the axis of rotation of the fan.

The progressiveness between a spacing angle 202 and an adjacent spacing angle 206 can be characterised by a positive function. Preferably, this function is linear and has a strictly positive slope. In some embodiments, the slope is strictly greater than 1.

The progressiveness of the angular distribution of the blades is preferably applied to all the blades. In some embodiments, the progressiveness of the angular distribution is applied to at least three blades.

The angular distribution of the blades is such that the sum of the spacing angles between corresponding characteristic points is equal to 360°.

The ratio between the smallest spacing angle 208 and the largest spacing angle 207 is preferably more than 1.2.

Preferably, the minimum length of arc between two blades is more than 3 mm, and the smallest distance between two consecutive blades is more than 3 mm. The length of arc can be calculated between two end of blade points of two adjacent blades between which the spacing angle is the smallest spacing angle 208.

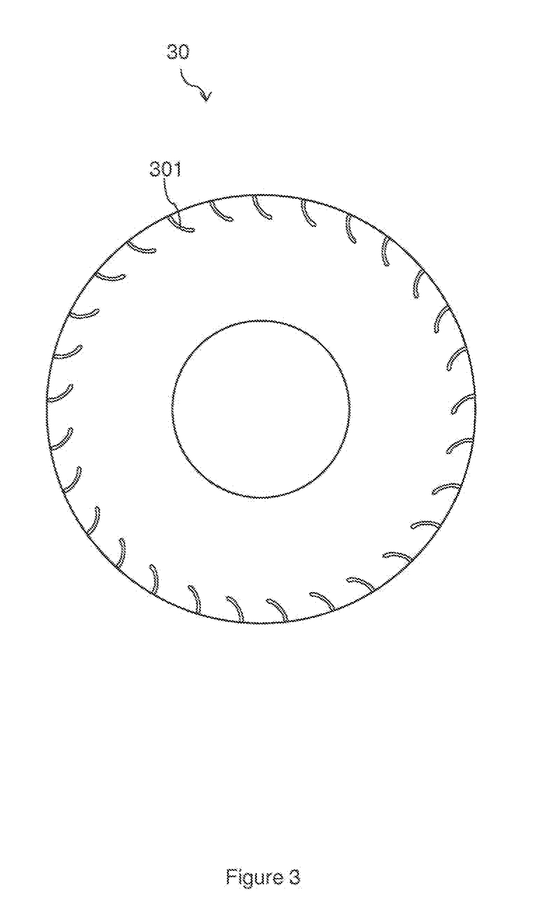

FIG. 3 shows a front view of a particular embodiment 30 of a fan with symmetrical distribution of blades.

The fan 30 comprises blades 301. The blades 301 can be placed perpendicularly to a face, and the distribution of the blades can be symmetrical as far as the spacing angle is concerned. The blades are all similar, i.e. they have the same length, the same height and the same angle of inclination. The blades 301 can be concave or convex.

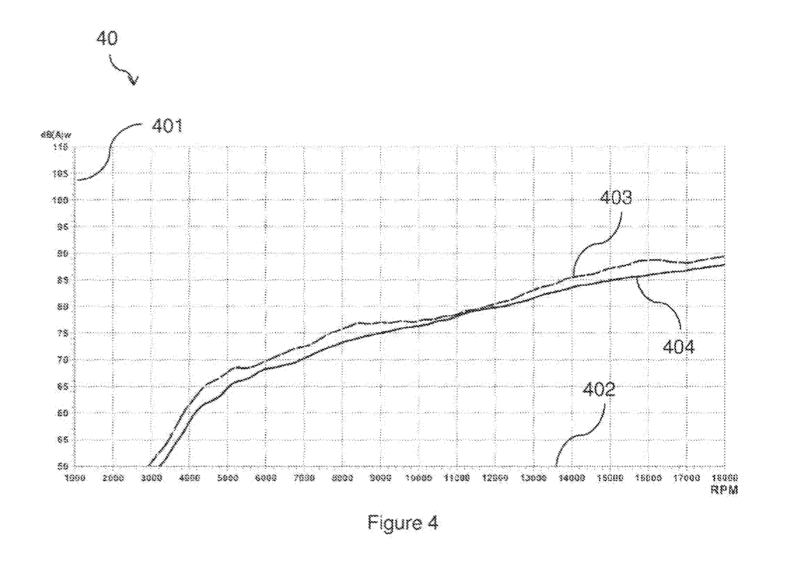

FIG. 4 shows a graph 40 which is representative of the amplitude of a harmonic of order twenty nine generated by an embodiment of a symmetrical fan 30 and of the amplitude of a harmonic of order twenty nine generated by an embodiment 100 of a fan which is the subject of the present invention.

The graph 40 has on the X-axis 401 the speed of rotation in revolutions per minute (RPM) of the fan. The Y-axis 402 is a weighted acoustic power measurement A in decibel watts (the acronym of which is dB(A)W) of the amplitude of a signal, and more particularly a sound signal.

The curve 403 represents the amplitude of the harmonic of order twenty nine of a symmetrical fan 30 for rotations between 0 and 18,000 revolutions per minute. The curve 404 represents the amplitude of the harmonic of order twenty nine of an embodiment 100 of a fan which is the subject of the present invention for rotations between 0 and 18,000 revolutions per minute.

The curves 403 and 404 have been obtained by the inventors from tests.

It can be observed that the curve 403 is at all points higher than the curve 404. The difference in amplitude between the curve 403 and the curve 404 is more than 3 dB(A)W at certain points of the curve. The curves 403 and 404 are strictly increasing. The maximum reached by the curve 403 in the measurement range is close to 90 dB(A)W, and the maximum reached by the curve 404 in the measurement range is close to 88 dB(A)W.

The curve 403 is lower than 50 dB(A)W from 0 to approximately 2900 revolutions per minute. The curve 404 is lower than 50 dB(A)W from 0 to approximately 3200 revolutions per minute.

The harmonic of order twenty nine caused by the rotation of a symmetrical fan 30 thus occurs earlier, and produces more noise than the harmonic of order twenty nine caused by the rotation of a symmetrical fan 10.

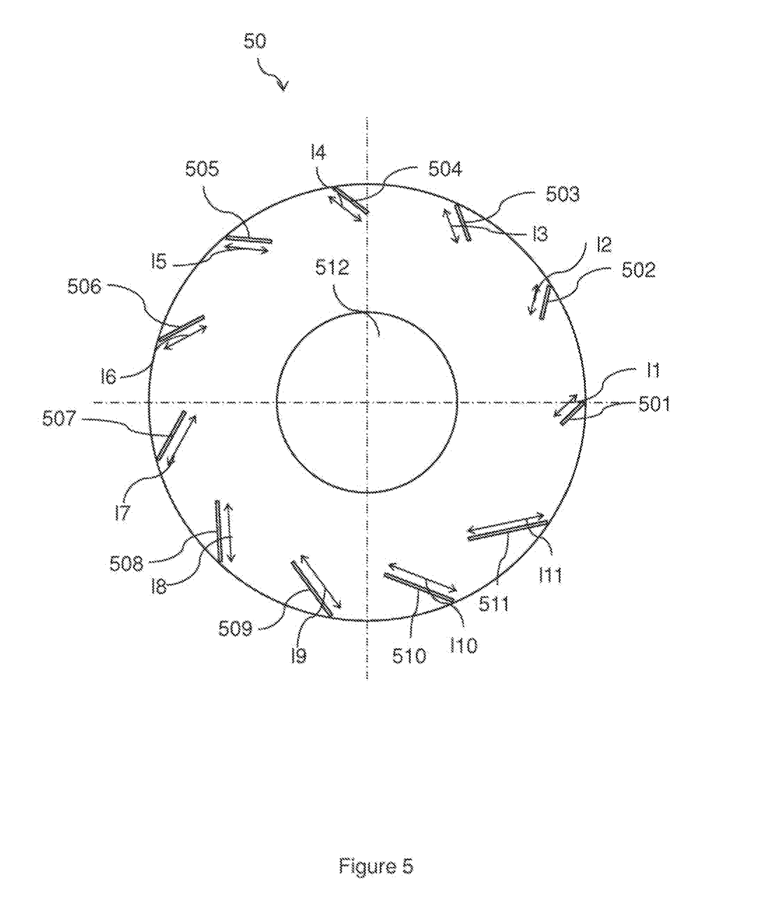

FIG. 5 shows a front view of a particular embodiment 50 of a fan which is the subject of the present invention.

The device comprises blades 501. Preferably, the number of blades 501 is a prime number. The device can comprise blades which are arranged perpendicularly to a face. The face can comprise an axial hole 512 which receives a shaft of a rotor of a rotary electrical machine. The face is preferably described by an outer diameter. The blades 501 can be straight.

In some embodiments, the blades are convex or concave.

The length of the blade can be defined as being the length of the curve of intersection between the outer face of the blade and the face of the fan comprising the blades. For example, the lengths l1, l2, l3, l4, l5, l6, l7, l8, l9, l10 and l11 of the blades 501 to 511 respectively are such that l1 is smaller than l2, which is smaller than l3 and so on, the longest length being l11.

The progressiveness between the length l1 of a blade 501 and the length l2 of a blade 502 can be characterised by a positive function. Preferably, this function is linear and has a strictly positive slope. In some embodiments, the slope is strictly greater than 1. The ratio between the length l11 of the largest blade 511 and the length l1 of the smallest blade 501 is more than 1.2.

The progressiveness of the length of the blades is preferably applied to all the blades. In some embodiments, the progressiveness of the length of the blades is applied to at least three blades. The blades have the same height for example.

Preferably, the minimum length of arc between two blades is more than 3 mm. For example, the smallest distance between two consecutive blades is more than 3 mm. The length of arc can be calculated between two ends of blade points of two adjacent blades.

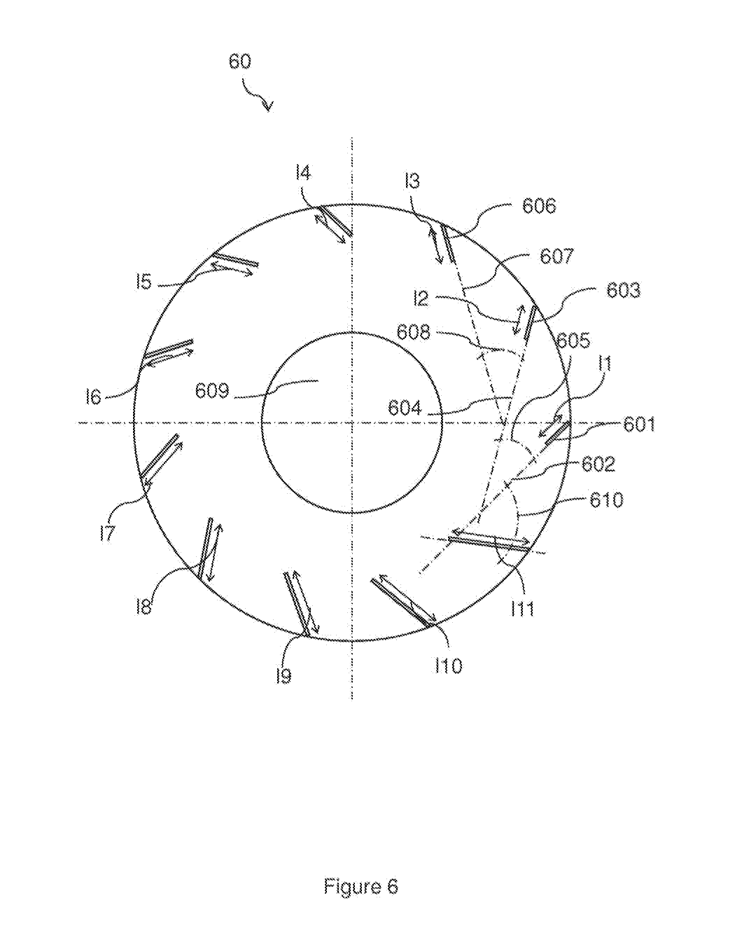

FIG. 6 shows a front view of a particular embodiment 60 of a fan which is the subject of the present invention.

The device comprises blades 601. Preferably, the number of blades 601 is a prime number. The device can comprise blades which are arranged perpendicularly to a face. The face can comprise an axial hole 609 which receives a shaft of a rotor of a rotary electrical machine. The face can preferably be described by an outer diameter. The blades 601 can be straight.

In some embodiments, the blades are convex or concave.

The length of the blade can be defined as being the length of the curve of intersection between the outer face of the blade and the face of the fan comprising the blades. For example, the lengths l1, l2, l3, l4, l5, l6, l7, l8, l9, l10 and l11 of the blades are such that that l1 is smaller than l2, which is smaller than l3 and so on, the longest length being l11.

The progressiveness between the length l1 of a blade 601 and the length l2 of a blade 603 can be characterised by a positive function. Preferably, this function is linear and has a strictly positive slope. In some embodiments, the slope is strictly greater than 1. The ratio between the length l11 of the largest blade and the length l1 of the smallest blade can be more than 1.2.

The progressiveness of the length of the blades is preferably applied to all the blades. In some embodiments, the progressiveness of the length of the blades is applied to at least three blades. The blades have the same height for example.

Angles of inclination between the blades can follow a progressive distribution. An angle of inclination 605 can be defined between:
a straight line 602 passing via:
   a characteristic point, known as the end of blade point, which can be the point of the blade, on the face of the fan comprising the blades, and on the outer face of the blade, which point is the furthest from the axis of rotation of the fan; and
   the axis of rotation of the fan; and
   a characteristic point known as the start of blade point, which can be the point of the blade, on the face of the fan comprising the blades, and on the outer face of the blade, which point is the closest to the axis of rotation of the fan:
a straight line 604 which passes via the corresponding characteristic points on the adjacent blade.

The progressiveness between an angle of inclination 605 and an adjacent angle of inclination 608 can be characterised by a positive function. Preferably, this function is linear and has a strictly positive slope. In some embodiments, the slope is strictly greater than 1.

The progressiveness of the angular inclination of the blades is preferably applied to all the blades. In some embodiments, the progressiveness of the angular inclination is applied to at least three blades.

The ratio between the smallest angle of inclination 605 and the largest angle of inclination 610 is preferably more than 1.2.

In some embodiments, the progressiveness of the angles of inclination and the progressiveness of the lengths are connected by a function.

Preferably, the minimum length of arc between two blades is more than 3 mm. For example, the smallest distance between two consecutive blades is more than 3 mm. The length of arc can be calculated between two end of blade points of two adjacent blades.

FIG. 7 shows a view in perspective of a particular embodiment 70 of a fan which is the subject of the present invention.

The device comprises blades 701. Preferably, the number of blades is a prime number. The device can comprise blades which are arranged perpendicularly to a face. The face can comprise an axial hole 704 which receives a shaft of the rotor of a rotary electrical machine. The face is preferably described by an outer diameter. The blades 701 can be straight.

In some embodiments, the blades are convex or concave.

The height of the blade can be defined as being a dimension taken perpendicularly to the face comprising the blades, between the face comprising the blades and the point of the blade which is furthest from the face comprising the blades.

The progressiveness between the height of a blade 701 and the height of a blade 702 can be characterised by a positive function. Preferably, this function is linear and has a strictly positive slope. In some embodiments, the slope is strictly greater than 1. The ratio between the height of the largest blade and the height of the smallest blade can be more than 1.2.

The progressiveness of the height of the blades is preferably applied to all the blades. In some embodiments, the progressiveness of the height of the blades is applied to at least three blades.

Preferably, the minimum length of arc between two blades is more than 3 mm. For example the smallest distance between two consecutive blades is more than 3 mm. The length of arc can be calculated between two end of blade points of two adjacent blades.

The face comprising the blades can comprise a progressive distribution of material 703 configured to balance the fan according to the progressiveness of the heights.

Preferably, the progressive distribution of material is carried out by addition of material in comparison with a fan according to an embodiment 70 without progressive distribution of material. The progressive addition of material can be carried out at the moment of production of the part. The addition of material can be a deposit of material, the quantity of which increases according to the circumference of the fan in a given direction. The addition of material can be localised on the periphery of an axial hole in the fan.

In some embodiments, the progressive distribution of material by addition of material is localised on the face of the fan parallel to the face comprising the blades.

In some embodiments, the progressive distribution of material is carried out by removal of material.

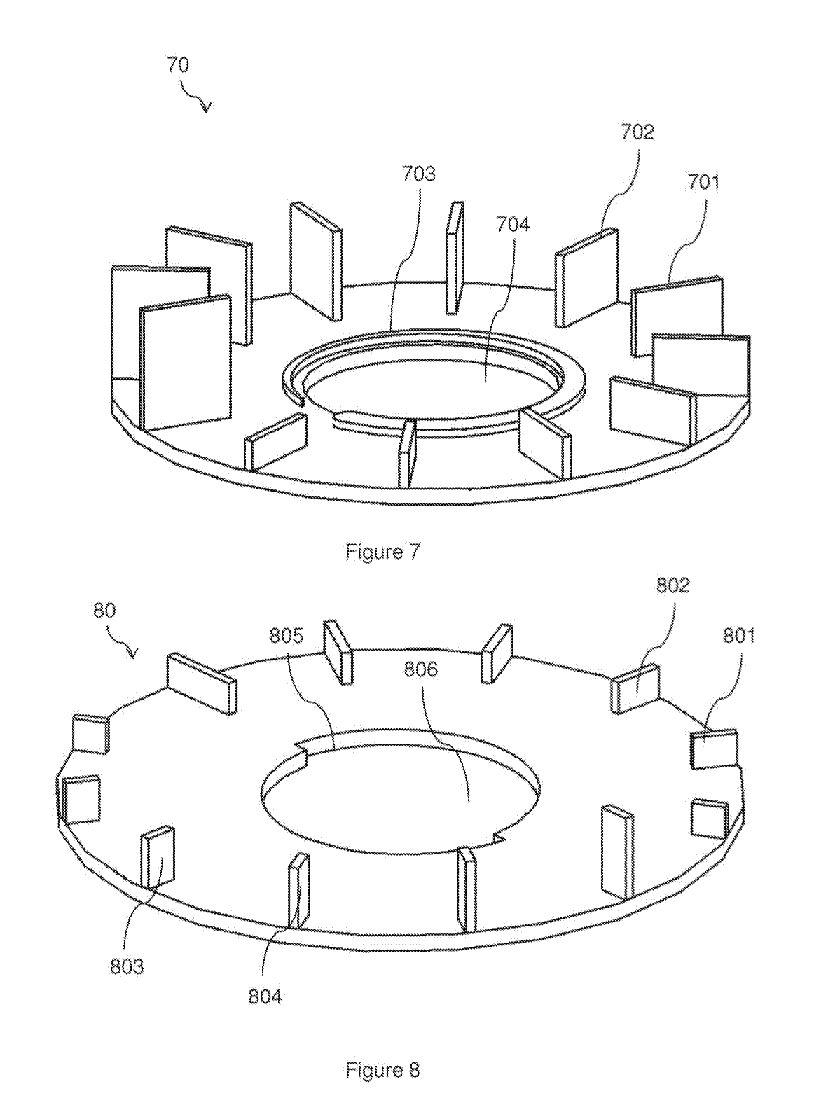

FIG. 8 shows a view in perspective of a particular embodiment 80 of a fan which is the subject of the present invention.

The embodiment 80 can comprise progressiveness of height for at least three blades and progressiveness of length for at least three other blades. Preferably, the progressiveness is applied to adjacent blades.

In some embodiments, groups of at least three blades can:
have progressiveness of the spacing angles;
have progressiveness of the height;
have progressiveness of the length;
have progressiveness of the angles of inclination;
have a combination of progressivenesses of at least two progressivenesses from out of the three preceding ones; or
not have any progressiveness.

In some embodiments, two groups of at least three different blades have the same progressiveness from amongst the choices listed in the preceding paragraph. The characteristics of the progressiveness can be identical or different.

Preferably, the spacing angle as defined as being between:
a straight line passing via:
   a characteristic point, known as the end of blade point, which can be the point of the blade, on the face of the fan comprising the blades, and on the outer face of the blade, which point is the furthest from the axis of rotation of the fan; and
   the axis of rotation of the fan;
a straight line passing via:
   a characteristic point on an adjacent blade also characterised as being an end of blade point; and
   the axis of rotation of the fan.

Preferably, the angle of inclination is defined as being between:
a straight line passing via:
   a characteristic point, known as the end of blade point, which can be the point of the blade, on the face of the fan comprising the blades, and on the outer face of the blade, which point is the furthest from the axis of rotation of the fan; and
   the axis of rotation of the fan; and
   a characteristic point, known as the start of blade point, which can be the point of the blade, on the face of the fan comprising the blades, and on the outer face of the blade, which point is closest to the axis of rotation of the fan;
a straight line passing via the corresponding characteristic points on the adjacent blade.

The device comprises blades 801. Preferably, the number of blades is a prime number. The device can comprise blades which are arranged perpendicularly to a face. The face can comprise an axial hole 806 which receives a shaft of a rotor of a rotary electrical machine. The face is preferably described by an outer diameter. The blades 801 can be straight.

In some embodiments the blades are convex or concave.

Some of the blades can have progressiveness in height, and others of the blades can have progressiveness in length.

The progressiveness between the length of a blade 801 and the length of a blade 802 can be characterised by a positive function. Preferably, this function is linear, and has a strictly positive slope. In some embodiments the slope is strictly greater than 1. The ratio between the length of the largest blade and the length of the smallest blade can be more than 1.2.

In some embodiments, the progressiveness of the length of the blades is applied to at least three blades. The blades to which the progressiveness of length is applied have the same height for example.

The progressiveness between the height of a blade 803 and the height of a blade 804 can be characterised by a positive function. Preferably, this function is linear and has a strictly positive slope. In some embodiments, the slope is strictly greater than 1. The ratio between the height of the highest blade and the height of the lowest blade can be more than 1.2.

In some embodiments, the progressiveness of the height of the blades is applied to at least three blades. The blades to which the progressiveness of height is applied have the same length for example.

Preferably, the minimum length of arc between two blades is more than 3 mm. For example, the smallest distance between two consecutive blades is more than 3 mm. The length of arc can be calculated between two end of blade points of two adjacent blades.

The face comprising the blades can comprise progressive distribution of material 805 configured to balance the fan according to the progressiveness of the heights and the lengths.

Preferably, the progressive distribution of material is carried out by removal of material relative to a fan according to an embodiment 80 without progressive distribution of material. The progressive removal of material can be carried out at the moment of production of the part or during a subsequent machining operation.

In some embodiments, at least two characteristics are progressive and are selected from the group comprising:

the spacing angle;

the length;

the height;

the angle of inclination.

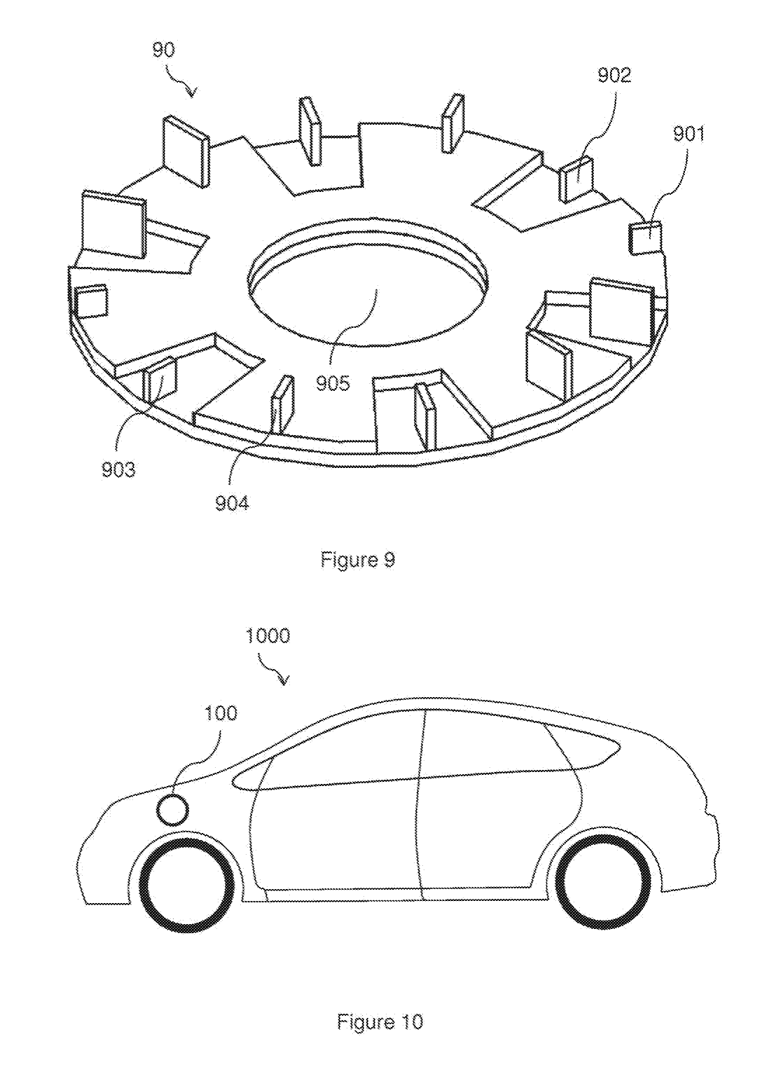

FIG. 9 shows a view in perspective of a particular embodiment 90 of a fan which is the subject of the present invention.

The embodiment 90 can comprise progressiveness of height and length for at least three blades. The progressiveness of height can depend on the progressiveness of length. For example, the height can vary proportionally to the length.

In some embodiments, the double progressiveness is applied to all the blades. In some embodiments, at least two characteristics are progressive and the characteristics of the progressivenesses are connected by a function. The characteristics which can be progressive are:

the spacing angles;

the length;

the height;

the angles of inclination.

Preferably, the spacing angle is defined as being between:
a straight line passing via:
   a characteristic point known as the end of blade point, which can be the point of the blade, on the face of the fan comprising the blades, and on the outer face of the blade, which point is furthest from the axis of rotation of the fan; and
   the axis of rotation of the fan;
a straight line passing via:
   a characteristic point on an adjacent blade also characterised as being an end of blade point; and
   the axis of rotation of the fan.

Preferably, the angle of inclination is defined as being between:
a straight line passing via:
   a characteristic point known as the end of blade point, which can be the point of the blade, on the face of the fan comprising the blades, and on the outer face of the blade, which point is furthest from the axis of rotation of the fan; and
   a characteristic point, known as the start of blade point, which can be the point of the blade, on the face of the fan comprising the blades, and on the outer face of the blade, which is point closest to the axis of rotation of the fan;
   a straight line passing via the corresponding characteristic points on the adjacent blade.

In some embodiments, at least two groups of at least three different blades can have the same progressiveness. The characteristics of the progressiveness can be identical or different.

In some embodiments, some of the blades can have progressiveness with a plurality of characteristics, and others of the blades can have progressiveness with a different plurality of characteristics.

The embodiment 90 comprises two assembled parts 903 and 904. Preferably, the assembly is carried out by welding. The part 903 can comprise blades 901. The part 904 can comprise blades 902. Preferably, the number of blades of the device is a prime number. For example, the sum of the number of blades 901 and the number of blades 902 is a prime number.

The device can comprise blades which are arranged perpendicularly to a face. The face can comprise an axial hole 905 which receives a shaft of a rotor of a rotary electrical machine. The face can preferably be described by an outer diameter. The blades 901 and 902 can be straight.

In some embodiments, the blades are convex or concave.

The progressivenesses of the device can be characterised by positive functions. Preferably, these functions are linear and have strictly positive slopes. In some embodiments, the slopes are strictly greater than 1. The ratio between the characteristic of the largest blade and the characteristic of the smallest blade can be more than 1.2.

Preferably, the minimum length of arc between two blades is more than 3 mm. For example, the smallest distance between two consecutive blades is more than 3 mm. The length of arc can be calculated between two end of blade points of two adjacent blades.

The face comprising the blades can comprise a progressive distribution of material configured to balance the fan according to the progressiveness of the heights and the lengths.

In some embodiments, the progressiveness of the blades can be independent from the direction of rotation of the fan.

The aforementioned embodiments can be:

made of material comprising mostly aluminum and obtained by bending;

made of material comprising mostly aluminum and obtained by moulding;

made of metal plate and obtained by bending; or

made of plastic material and obtained by moulding.

The aforementioned embodiments can be obtained by assembling two parts comprising blades. The two parts can be:

made of material comprising mostly aluminum and obtained by bending;

made of material comprising mostly aluminum and obtained by moulding;

made of metal plate and obtained by bending; or

made of plastic material and obtained by moulding.

Preferably, the two parts have the same material and the same production mode.

FIG. 10 shows a particular embodiment of the vehicle 1000 which is the subject of the present invention.

The vehicle 1000 can comprise a rotary electrical machine such as a motor, an alternator or an alternator-starter which comprises at least one fan 100. In some embodiments, the vehicle 1000 comprises an embodiment 20, 50, 60, 70, 80, 90, or any other embodiment previously cited of the fan which is the subject of the present invention. Preferably, the vehicle comprises two fans from amongst the embodiments previously cited. The two fans can be identical.

1. Fan (100) for a rotary electrical machine comprising at least three blades (101), wherein at least one characteristic of the blades is, according to the circumference of the fan in a given direction, progressive for at least three consecutive blades, the characteristic being able to be selected from the group comprising:
a spacing angle (102) between a straight line passing via a characteristic point (103) of a blade and an axis of rotation of the fan (104), and a straight line passing via a corresponding characteristic point (105) of an adjacent blade and the axis of rotation of the fan;
a height of the blade;
a length of the blade; and
an angle of inclination (605) between a straight line (602) passing via two characteristic points of a blade, and a straight line (604) passing via two corresponding characteristic points of an adjacent blade.

2. Fan (100) for a rotary electrical machine according to claim 1, wherein at least one characteristic of the blades (101) is progressive for all of the blades of the fan.

3. Fan (100) for a rotary electrical machine according to claim 1, wherein the number of blades (101) is a prime number.

4. Fan (100) for a rotary electrical machine according to claim 1, wherein the sum of the spacing angles (102) between the blades (101) is equal to 360°.

5. Fan (100) for a rotary electrical machine according to claim 1, wherein the smallest distance between two consecutive blades (101) is more than 3 mm.

6. Fan (100) for a rotary electrical machine according to claim 1, wherein the minimum length of arc between two blades (101) is more than 3 mm.

7. Fan (100) for a rotary electrical machine according to claim 1, wherein the progressiveness of the spacing angles (102) between the blades (101) is defined by a positive function.

8. Fan (100) for a rotary electrical machine according to claim 4, wherein the function of progressiveness of the spacing angles (102) between the blades (101) is linear.

9. Fan (100) for a rotary electrical machine according to claim 7, wherein the ratio between the largest spacing angle (107) between two blades and the smallest spacing angle (108) between two blades is more than 1.2.

10. Fan (50) for a rotary electrical machine according to claim 1, wherein the progressiveness of the length (l1) of the blade (501) is defined by a positive function.

11. Fan (50) for a rotary electrical machine according claim 10, wherein the function of progressiveness of the length (l1) of the blade (501) is linear.

12. Fan (50) for a rotary electrical machine according to claim 10, wherein the ratio between the length (l11) of the largest blade (511) and the length (l1) of the smallest blade (501) is more than 1.2.

13. Fan (60) for a rotary electrical machine according to claim 1, wherein the progressiveness of the angles of inclination (605) between the blades (601) is defined by a positive function.

14. Fan (60) for a rotary electrical machine according to claim 13, wherein the function of progressiveness of the angles of inclination (605) between the blades (601) is linear.

15. Fan (60) for a rotary electrical machine according to claim 13, wherein the ratio between the largest angle of inclination (610) and the smallest angle of inclination (605) is more than 1.2.

16. Fan (70) for a rotary electrical machine according to claim 1, wherein the progressiveness of the height of the blade (701) is defined by a positive function.

17. Fan (70) for a rotary electrical machine according to claim 14, wherein the function of progressiveness of the height of the blade (701) is linear.

18. Fan (70) for a rotary electrical machine according to claim 16, wherein the ratio between the height of the largest blade (701) and the height of the smallest blade is more than 1.2.

19. Fan (80) for a rotary electrical machine according to claim 1, wherein at least two characteristics of the blades (801) are progressive.

20. Fan (90) for a rotary electrical machine according to claim 19, wherein the progressiveness of at least one characteristic of the blade (901) depends on the progressiveness of at least one other characteristic of the blade.

21. Fan (70) for a rotary electrical machine according to claim 1, which comprises progressive distribution of material (703) configured to balance the fan according to the progressiveness of at least one characteristic of at least three blades (701).

22. Fan (70) for a rotary electrical machine according to claim 21, wherein the progressive distribution of material (703) is carried out by addition of material.

23. Fan (70) for a rotary electrical machine according to claim 22, wherein the addition of material (703) is carried out by depositing material, the quantity of which increases according to the circumference of the fan in a given direction.

24. Fan (70) for a rotary electrical machine according to claim 23, wherein the depositing (703) is situated on the periphery of an axial hole (704) in the fan.

25. Fan (80) for a rotary electrical machine according to claim 21, wherein the progressive distribution of material (805) is carried out by removal of material.

26. Fan (100) for a rotary electrical machine according to claim 1, wherein the production material of at least one part of the fan comprises mostly aluminum.

27. Fan (100) for a rotary electrical machine according to claim 1, wherein at least one part of the fan is obtained from sheet metal.

28. Fan (100) for a rotary electrical machine according to claim 26, wherein at least one part of the fan is obtained by bending.

29. Fan (100) for a rotary electrical machine according to claim 1, wherein at least one part of the fan is made of plastic material.

30. Fan (100) for a rotary electrical machine according to claim 26, wherein at least one part of the fan is obtained by moulding.

31. Fan (90) for a rotary electrical machine according to claim 1, which is obtained by assembling at least two parts (903 and 904) comprising blades.

32. Vehicle (1000) comprising at least one fan (100) according to claim 1.
